(19) United States
(12) Patent Application Publication
(10) Pub. No.: US 2006/0156889 A1
(43) Pub. Date: Jul. 20, 2006

(54) E-Z line clamp and cutter

(76) Inventor: Lyle Francis Johnson, Wasilla, AK (US)

Correspondence Address: LYLE FRANCIS JOHNSON, PO BOX 871051, WASILLA, AK, 99687-1051, US

(21) Appl. No.: 10/810,411

(22) Filed: Mar. 25, 2004

(51) Int. Cl. B26D 7/01; A01K 97/06

(52) U.S. Cl. 83/649; 43/54.1

(57) ABSTRACT

Clamp is made by injecting a clear plastic PET-G into a mold which forms a slot and four posts for a stainless steel cutter, when the formed clamp is removed from the mold it is then put into a machine that has a heated tube that will allow the plastic to be softened slightly so it can take on the shape of a spring loaded clamp, then cold air is injected into the tube to make the plastic rigid which allows it to hold its shape, the stainless steel cutter has four holes which were punched into the platform which allows cutter to be installed onto the posts, the posts are heated with a concaved hot tip tool that makes a mushroom shaped cap that bonds the cutter to the clamp. Used for keeping line from unraveling on standard size fishing line spools.

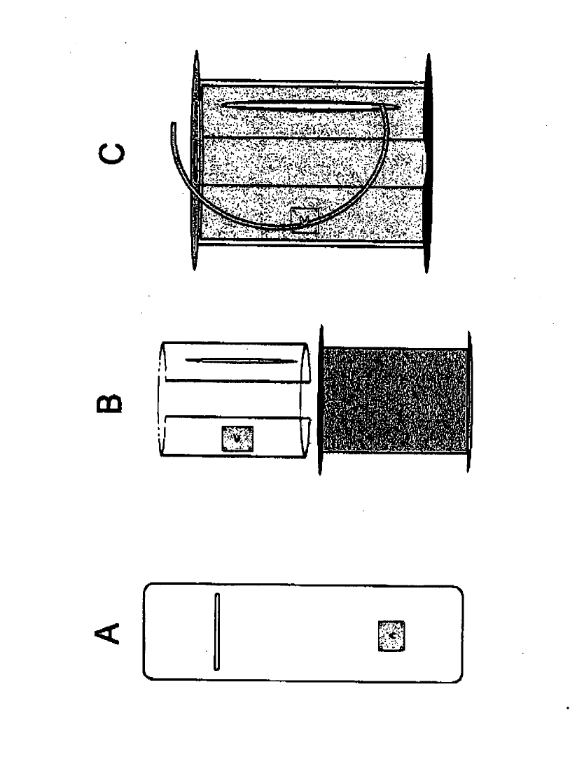

The Clamp is made of a clear plastic shaped so it can form around a spool of fishing line that will help keep line from unraveling off spool with a slot to feed it through so tie line can still be pulled off the spool and a cutter that will allow the user to cut the line off at any desired length.

1. Its been designed so the amateur and pro fishermen can keep many different types and sizes of monofilament, nylon or braided nylon line on the spool so they would not go through the inconvenience of the line coming loose from the spool.

2. The clamp has a slot to feed the line through so the angler can retrieve the line and be able to pull it through.

3. A cutter has been applied to the clamp so that the line could be cut of at any desired length.

4. The clamp keeps tension on line from beginning to end.

The clamp is made of a flexible PET-G plastic that is injected into a mold and then is taken and shaped around a heated tube to which will shape it into a spring formed round cylinder shape.

1. The 30/1000 inch thick by 2⅜ inch wide by 6½ inch long that was designed to fit around standard size spools of fishing line to help keep it from unraveling

2. It has a slot ⅛ inch wide 1¾ inch long that has a 15/1000 inch bead which will allow the user to feed line through it.

3. The clamp also has four posts which a cutter would be installed upon.

4. The cutter is punched out from stainless steel ½ inch by ½ inch by 30/1000 thick square with a raised ⅛ inch by ⅛ inch U shaped cutter and four 1/16 inch holes one in each corner that will be used to install cutter onto clamp.

5. The cutter is installed to the clamp using the four posts on the plastic and the holes on the cutter and then hot tipped on using a heated tool that will melt the plastic that is protruding though the holes causing a domed shape which will affix it into place making it part of the plastic clamp.

6. When used in it proper application the clamp will help to keep line from unraveling on most standard size spools of fishing line by clamping around the spool holding it into place, with a slot that the user will be able to feed line out of and a cutter that will cut the line off to any desired length and hold the line in place.

1. The Easy Line Clamp and Cutter has been designed so the amateur and pro fishermen can keep their monofilament or nylon line on the spool with out it coming unraveling.
It has a slot to feed the line through, and a convenient cutter to cut the line off at any desired length.
It keeps tension on line from beginning to end.
